(19) United States
(12) Patent Application Publication
(10) Pub. No.: US 2025/0145477 A1
(43) Pub. Date: May 8, 2025

(54) METHODS FOR MAKING ZEOLITE-Y PARTICLES

(71) Applicant: Saudi Arabian Oil Company, Dhahran (SA)

(72) Inventors: Faisal Alotaibi, Al-Khobar (SA); Lianhui Ding, Dhahran (SA)

(73) Assignee: Saudi Arabian Oil Company, Dhahran (SA)

(21) Appl. No.: 18/500,496

(22) Filed: Nov. 2, 2023

(51) Int. Cl. C01B 39/24; B01J 29/08; B01J 35/02; B01J 35/10

(52) U.S. Cl. CPC C01B 39/24; B01J 29/084; B01J 35/40; B01J 35/617; B01J 35/635; B01J 35/647; C01P 2004/62; C01P 2006/12; C01P 2006/14; C01P 2006/16

(57) ABSTRACT

A method for making zeolite-Y particles may include forming a zeolite precursor solution that may include an alumina source material and a silica source material in a solvent. The method may also include subjecting the zeolite precursor solution to a heating process to form the zeolite-Y particles. The heating process may include a first heating treatment and a second heating treatment. The second heating treatment may follow the first heating treatment. The first heating treatment may include exposure to a temperature of from 50° C. to 120° C. under non-autoclave conditions and the second heating treatment may include exposure to a temperature of from 80° C. to 120° C. under autoclave conditions.

### FIELD

The embodiments described herein generally relate to porous materials and, more particularly, to zeolites.

### BACKGROUND

Materials that include pores, such as zeolites, may be utilized in many petrochemical industrial applications. For instance, such materials may be utilized as catalysts in a number of reactions that convert hydrocarbons or other reactants from feed chemicals to product chemicals. Zeolites may be characterized by a microporous structure framework type. Various types of zeolites have been identified over the past several decades, where zeolite types are generally described by framework types, and where specific zeolitic materials may be more specifically identified by various names such as ZSM-5 or zeolite-Y.

Zeolite containing catalysts and adsorbents have widespread uses in many diverse industries. Exemplary industries include the petrochemical industry in refinery, gas separation, and carbon dioxide separation and capture processes. In the petroleum industry, for example, zeolite containing catalysts may be included in processes such as fluid catalytic cracking (FCC) and hydrocracking to catalyze reactions such as hydrogenation, dehydrogenation, isomerization, alkylation, and cracking, for example. Zeolite containing adsorbents may be utilized in the separation of paraffins or aromatic isomers, and in drying processes to remove water and other impurities from hydrocarbon streams.

### SUMMARY

Embodiments of the present disclosure are directed to methods of making zeolite-Y particles. In particular, the methods of making zeolite-Y particles may comprise forming a zeolite precursor solution and subjecting the zeolite precursor solution to a heating process comprising a first heating treatment and a second heating treatment. In conventional embodiments, autoclave conditions were generally utilized for the first heating treatment. It has been discovered that the first heating treatment may be under non-autoclave conditions. Thus allows, in some embodiments, for the first heating treatment to be conducted in the same vessel as the formation of the zeolite precursor solution. Performing these two steps without transferring the zeolite precursor solution may reduce the amount of time required to treat the zeolite precursor solution to form zeolite-Y particle when compared to methods that perform these steps in separate vessels. Accordingly, the methods of the present disclosure may be cheaper and simpler to perform than methods that utilize separate vessels for these steps.

According to one or more embodiments, a method for making zeolite-Y particles may comprise forming a zeolite precursor solution that may comprise an alumina source material and a silica source material in a solvent. The method may also comprise subjecting the zeolite precursor solution to a heating process to form the zeolite-Y particles. The heating process may comprise a first heating treatment and a second heating treatment. The second heating treatment may follow the first heating treatment. The first heating treatment may comprise exposure to a temperature of from 50° C. to 120° C. under non-autoclave conditions and the second heating treatment may comprise exposure to a temperature of from 80° C. to 120° C. under autoclave conditions.

It is to be understood that both the preceding general description and the following detailed description describe various embodiments and are intended to provide an overview or framework for understanding the nature and character of the claimed subject matter. Additional features and advantages of the embodiments will be set forth in the detailed description and, in part, will be readily apparent to persons of ordinary skill in the art from that description, which includes the accompanying drawings and claims, or recognized by practicing the described embodiments. The drawings are included to provide a further understanding of the embodiments and, together with the detailed description, serve to explain the principles and operations of the claimed subject matter. However, the embodiments depicted in the drawings are illustrative and exemplary in nature, and not intended to limit the claimed subject matter.

### DETAILED DESCRIPTION

One or more embodiments presently described herein are directed to methods of making zeolite-Y particles. In some embodiments, the zeolite-Y particles are nano-sized, as described herein.

As used throughout this disclosure, “zeolites” or “zeolite materials” generally refer to micropore-containing inorganic materials with regular intra-crystalline cavities and channels of molecular dimension, as would be understood by those skilled in the art. Zeolites generally comprise a crystalline structure, as opposed to an amorphous structure. The microporous structure of zeolites may render large surface areas and desirable size-/shape-selectivity, which may be advantageous for catalysis. Accordingly, zeolites may be utilized in many petrochemical industrial applications, such as, for instance, reactions that convert hydrocarbons or other reactants from feed chemicals to product chemicals by cracking.

Generally, zeolites may be characterized by a microporous framework type, which defines their microporous structure. Framework types are described in, for instance, “Atlas of Zeolite Framework Types” by Christian Baerlocher et al., Sixth Revised Edition, published by Elsevier, 2007, the teachings of which are incorporated by reference herein.

As described herein, the zeolites formed are zeolite-Y. Zeolite-Y generally comprises an FAU framework type. Zeolite-Y described herein may be characterized, in some embodiments, as ultra-stable zeolite-Y (USY). As used herein, “zeolite-Y” and “USY” refer to a zeolite having a FAU framework type according to the IZA zeolite nomenclature and consisting majorly of silica and alumina, as would be understood by one skilled in the art.

According to the methods for making zeolite-Y particles described herein, in general, a zeolite precursor solution may be formed and the zeolite precursor solution may be subjected to a heating process comprising first and second heat treatments to form zeolite-Y particles. The zeolite precursor solution may be formed and subjected to the first heating treatment in the same vessel. These steps are discussed in detail hereinbelow.

As described hereinabove, in one or more embodiments, in an initial step, a zeolite precursor solution is formed. Generally, zeolite precursor solutions may refer to those that include the materials that will form the zeolite, such as silicon, aluminum, and oxygen atoms. Zeolite precursor solutions may include a solvent and at least an alumina source material and a silica source material. The zeolite precursor solution may further comprise a basic compound, as described herein. The solvent may be water, but other solvents are not necessarily excluded from the scope of the presently disclosed methods.

Without limitation, the alumina source materials may comprise one or more of alumina, NaAlO₂, Al₂(SO₄)₃, Al(NO₃)₃, AlCl₃, NaAlO₂, or Al₂O₃. Also, without limitation, the silica source material may comprise one or both of colloidal silica, fumed silica, or tetraethyl orthosilicate (TEOS), or Na₂SiO₃. It should be understood that molecules of source materials may disassociate in solution, and that the initial zeolite precursor solution comprising an alumina source material or a silica source material may refer to the initial zeolite precursor solution comprising the initial molecules of the source materials or disassociated components of these molecules. The basic compound may be chosen from NaOH, KOH, Mg(OH)₂, and the basic compound composition is not necessarily limited. In some embodiments, the alumina source material may not be aluminum isopropoxide.

According to one or more embodiments, the zeolite precursor solution may generally be prepared by mixing the alumina source material and the silica source material into a solvent. For example, the alumina source material may be mixed into a solvent, the silica source material may be mixed into another solvent, and these two mixtures may be combined. The ordering of combination of the mixing of the alumina source material and the silica source material into the solvent is not necessarily limited. Similarly, a basic compound may be mixed into the solution that includes the alumina source material and silica source material, or may be added already mixed with the solvent.

According to one or more embodiments, the mixture that includes the alumina source material and silica source material may be aged to form the zeolite precursor solution. Aging may be for a period of time of at least 10 hours, such as from 10 hours to 48 hours, from 10 hours to 30 hours, or from 15 hours to 25 hours. The aging may include agitating the mixture, such as stirring the mixture. In some embodiments, the aging may be at an elevated temperature, such as about 30° C., but in other embodiments the aging may be at ambient temperature such as about 25° C. Without being bound by theory, while it is not believed that the overall chemical composition substantially changes in the mixture during aging, it is believed that aging may form zeolite nuclei from which zeolitic particles may be formed in downstream steps by crystallization. In general, final crystal sizes may be smaller when more nuclei are formed during aging, and relatively small crystal size and particle size may be desired.

In one or more embodiments, the molar ratio of components in the zeolite precursor solution may be 8-12 Na₂O:1 Al₂O₃:6-20 SiO₂:200-400 H₂O. Molar ratios of any two of these components are contemplated herein based on the described molar ratio of Na₂O, alumina, silica, and water.

In one or more embodiments, the method of making zeolite-Y particles may exclude the use of an organic structure-directing agent, which in conventional embodiments, may be incorporated into the zeolite precursor solution. For example, the method may not utilize one or more of tetraethylammonium cation, N,N-dimethyl-2,6-cis-dimethylpiperdinium cation, dimethyldiisopropylammonium cation, N,N,N-trimethylcyclohexanaminium cation, N-ethyl-N,N-dimethylcyclohexanaminium cation, N-isopropyl-N-methyl-pyrrolidinium cation, N-isopentyl-N-methyl-pyrrolidinium cation, and N-isobutyl-N-methyl-pyrrolidinium cation. Without being bound by theory, it is believed that the methods of making zeolite-Y particles of the present disclosure that do not utilize an organic structure-directing agent may be less costly than comparable methods of making zeolite-Y particles that do utilize an organic structure-directing agent.

Following the forming of the initial zeolite precursor solution, the initial zeolite precursor solution may be subjected to a heating process, which may crystalize a portion of the materials in the initial zeolite precursor solution to form the zeolite-Y particles. Portions of the heating process may be under increased pressure and/or at relatively high levels of humidity as compared to ambient environmental conditions, such as those present in an autoclave. For example, a portion of or the entirety of the heating process may be performed in an autoclave at autoclave conditions. As would be understood in to those in the art, autoclave conditions may generally include autogenous pressure and steam. Other portions of the heating process, as described herein, may be performed under non-autoclave conditions. For example, in some embodiments, a heating step may be under non-autoclave conditions, such as relatively dry conditions in an oven with near atmospheric humidity.

According to one or more embodiments, the heating process may comprise two heat treatments, a first heat treatment at a temperature of from 50° C. to 100° C., and a second heat treatment (following the first heat treatment) at a temperature of from 80° C. to 120° C. The first heat treatment may be under non-autoclave conditions and the second heat treatment may be under autoclave conditions. This aspect may be distinct from conventional fabrication methods that utilized two heating treatments both under autoclave conditions.

The first heat treatment may be for a time period of from 12 hours to 96 hours, and the second heat treatment may be for a time period of from 12 hours to 24 hours. For example, the first heat treatment may be at a temperature of from 50° C. to 60° C., from 60° C. to 70° C., from 70° C. to 80° C., from 80° C. to 90° C., from 90° C. to 100° C., or any combination of one or more of these ranges, for a time period of from 12 hours to 16 hours, from 16 hours to 20 hours, from 20 hours to 24 hours, from 24 hours to 28 hours, from 28 hours to 32 hours, from 32 hours to 36 hours, from 36 hours to 40 hours, from 40 hours to 44 hours, from 44 hours to 48 hours, from 48 hours to 32 hours, from 28 hours to 32 hours, or any combination of one or more of these ranges. Also, for example, the second heat treatment may be at a temperature of from 80° C. to 90° C., from 90° C. to 100° C., from 100° C. to 110° C., from 110° C. to 120° C., or any combination of one or more of these ranges, for a time period of from 4 hours to 8 hours, from 8 hours to 12 hours, from 12 hours to 16 hours, from 16 hours to 20 hours, from 20 hours to 24 hours, or any combination of one or more of these ranges.

In one or more embodiments, the zeolite precursor solution may be formed in a vessel and then subjected to the first heat treatment without being removed from the vessel, such that forming the zeolite precursor solution and performing the first heating treatment are done in the same vessel. Without being bound by theory, it is believed that by performing the first heat treatment and forming the zeolite precursor solution in the same vessel the complexity and associated cost of the method of making zeolite-Y particles of the present disclosure may be reduced when compared to methods that do not perform the first heat treatment and form the zeolite precursor solution in the same vessel.

In one or more embodiments, the heating of the initial zeolite precursor solution forms the crystalized zeolite-Y particles in a residual liquid solution. In one or more embodiments, following the formation of the zeolite-Y particles in residual liquid solution, the zeolite-Y particles are separated from the residual liquid solution. Separation may be by a wide variety of techniques, and generally phase separation techniques may be suitable since the zeolite-Y particles are solids and the residual liquid solution is a liquid. For example, centrifugation may be utilized to separate the zeolite-Y particles from the residual liquid solution. Separation of the zeolite-Y particles may be complete or incomplete where, for example, some small amount of zeolite-Y particles remain in the residual liquid solution, but this is not desirably the case.

Following separation of the zeolite-Y particles from the residual liquid solution, the zeolite-Y particles may be washed and/or dried. Washing may be with water, and may be conducted until the pH of the zeolite-Y particles is from about 8 to 9. Drying may be by presence in ambient conditions or by heating, such as relatively low temperature heating. Following drying, the zeolite-Y particles may be calcinated by exposure to heat. The calcination may be performed by exposure to temperatures of from 300° C. to 500° C. for 4 to 10 hours.

As described herein, the zeolite-Y is formed as particles. The particles may be shaped particles, such as spheres, or may be inconsistent in shape or otherwise globular in shape, and shape of the particles is not necessarily limited in embodiments described herein. As described herein, the size of a particle refers to the maximum length of a particle from one side to another, measured along the longest distance of the particle. For example, a spherically shaped particle has a size equal to its diameter, or a rectangular prism shaped particle has a maximum length equal to the hypotenuse stretching from opposite corners. Particle size may be measured by a variety of known techniques such as laser diffraction analysis or microscopy. In one or more embodiments, the zeolite-Y particles may be nano-sized meaning that they have an average particle size of less than 1 micron. In some embodiments, the zeolite-Y particles may have an average diameter of from 150 nm to 250 nm, such as from 150 nm to 160 nm, from 160 nm to 170 nm, from 170 nm to 180 nm, from 180 nm to 190 nm, from 190 nm to 200 nm, from 200 nm to 210 nm, from 210 nm to 220 nm, from 220 nm to 230 nm, from 230 nm to 240 nm, from 240 nm to 250 nm, or any combination of one or more of these ranges.

In one or more embodiments, the zeolite-Y particles described may include, in addition to micropores (present in the microstructure of a zeolite), mesopores, and the zeolite-Y particles may be mesoporous by having an average pore size of greater than 2 nm and less than or equal to 50 nm. Unless otherwise described herein, the “pore size” of a material refers to the average pore size, but materials may additionally include mesopores having a particular size that is not identical to the average pore size. The average pore size of a material can be measured using BET analysis, as is widely understood to those in the art. According to one or more embodiments, the zeolite-Y particles may have an average pore size of greater than 2 nm, such as from 2 nm to 5 nm, such as from 2 nm to 2.5 nm, from 2.5 nm to 3 nm, from 3 nm to 3.5 nm, from 3.5 nm to 4 nm, from 4 nm to 4.5 nm, from 4.5 nm to 5.0 nm, or any combination of one or more of these ranges.

In one or more embodiments, the zeolite-Y may have an average micropore volume and/or an average mesopore volume, where the total pore volume is the sum of these two. The mesopore and micropore volumes may be calculated according to the Barrett-Joiner-Halenda (BJH) method of determining mesopore volume known to one having skill in the art. Details regarding the t-plot method and the BJH method of calculating micropore volume and mesopore volume respectively are provided in Galarneau et al., “Validity of the t-plot Method to Assess Microporosity in Hierarchical Micro/Mesoporous Materials”, Langmuir 2014, 30, 13266-13274, for example. In one or more embodiments, the zeolite-Y particles may have a total pore volume of from 0.5 ml/g to 1.0 ml/g, such as from 0.5 ml/g to 0.55 ml/g, from 0.55 ml/g to 0.6 ml/g, from 0.6 ml/g to 0.65 ml/g, from 0.65 ml/g to 0.7 ml/g, from 0.7 ml/g to 0.75 ml/g, from 0.75 ml/g to 0.8 ml/g, from 0.8 ml/g to 0.85 ml/g, from 0.85 ml/g to 0.9 ml/g, from 0.9 ml/g to 0.95 ml/g, from 0.95 ml/g to 1.0 ml/g, or any combination of one or more of these ranges.

In one or more embodiments, the zeolite-Y particles may have an average surface area of at least 500 m²/g, such as at least 550 m²/g, at least 600 m²/g, at least 650 m²/g, at least 700 m²/g, or even at least 750 m²/g, as determined through the Brunauer-Emmett-Teller (BET) method (average BET surface area).

As described herein, crystallinity is a measurement of the degree of structural order in a solid. A more crystalline solid will have its atoms and molecules arranged in a more regular and periodic manner than a less crystalline solid. Crystallinity is typically determined by x-ray diffraction. A particular diffraction peak can be selected and its intensity normalized. Zeolites can be analyzed and the diffraction intensity normalized against the standard producing a relative crystallinity based on a standard zeolite structure. In one or more embodiments, the zeolite-Y particles may have a relative crystallinity based on the crystallinity of CBV-100, available from Zeolyst International, of greater than 100%.

The zeolite-Y particles described herein may be utilized alone or in combination with other materials as catalyst used in hydrocracking processes. Such a process may have at least two functions: cracking of high molecular weight hydrocarbon and hydrogenating the unsaturated molecules. However, the relatively small pore size (e.g. average pore size less than 2 nm) of most conventional zeolites Y materials in hydrocracking catalysts generally does not favor the transport of large molecules in heavy oil fractions to diffuse into the active sites located inside the zeolite. This may cause low activity, and a possible deactivation of the catalyst. Additionally, the poor diffusion efficiency of bulky molecules can be avoided by reduced zeolite particle size due to increased external surface area and shortened diffusion path of the molecules. However, the relatively small particle size of the presently disclosed zeolite-Y materials may enable for better access of reactive molecules to catalytic sites.

### EXAMPLES

The various embodiments of methods described will be further clarified by the following examples. The examples are illustrative in nature, and should not be to limit the subject matter of the present disclosure.

### Comparative Example A (CE-A)-Zeolite with Conventional Synthesis

First 68.0 g of sodium hydroxide (NaOH) was dissolved in 392.4 g of water in a glass bottle. To this mixture 16.4 g of sodium aluminate (NaAlO₂) and 210 g of 40 wt. % colloidal silica was added and stirred for 1 hour. The mixture was then stirred and aged at 30° C. for 20 hours. The resulting hydrogel mixture was next transferred to a different vessel for autoclaving at 60° C. for 12 hours for first stage crystallization, then temperature was increased to 100° C. for 12 hours for second stage crystallization in an autoclave. The obtained mixture was filtrated and washed with water until its pH reached between 8 and 9. The resulting solid product was dried at 110° C. for 24 hours and then calcinated at 500° C. for 4 hours (2° C./min ramp).

### Example 1 (EX-1)—Zeolite with One Pot Synthesis Method

First 68.0 g of NaOH was dissolved in 392.4 g of water in a glass bottle. To this mixture 16.4 g of NaAlO₂ and 210 g of 40 wt. % colloidal silica was added and stirred for 1 hour. The mixture was then stirred and aged at 30° C. for 20 hours. The resulting hydrogel mixture was left in the same bottle used for aging and heated under about atmospheric pressure and humidity at 60° C. for 12 hours in an oven for first stage crystallization. The mixture was then transferred to a new vessel and autoclaved at a temperature of 100° C. for 12 hours for second stage crystallization. The obtained mixture was filtrated and washed with water until its pH reached between 8 and 9. The resulting solid product was dried at 110° C. for 24 hours and then calcinated at 500° C. for 4 hours (2° C./min ramp). The zeolites produced in Comparative Example A and Example 1

TABLE 1
Main Properties of CE-A and EX-1 Zeolites

| Sample Name | CE-A | EX-1 |
|---|---|---|
| Average particle sizes, nm | 200 | 200 |
| Crystallinity % | 90.0 | 90.0 |
| Bulk Si/Al, mol/mol | 1.90 | 1.80 |
| Framework Si/Al, mol/mol | 1.60 | 1.80 |
| Total surface area, m²/g | 656 | 666 |
| Micropore surface area, m²/g | 577 | 597 |
| Mesopore surface area, m²/g | 79.0 | 69.0 |
| Total pore volume, ml/g | 0.57 | 0.67 |
| Micro pore volume, ml/g | 0.30 | 0.31 |
| Mesopore volume, ml/g | 0.27 | 0.35 |
| Pore size, nm | 3.50 | 4.00 |
| Solid product Yield, wt % | 45.0 | 43.9 |

As shown in Table 1, the zeolite-Y particles produced in Example 1 showed similar or improved properties to the zeolite-Y particles produced in Comparative Example 1. This indicates that performing the first stage of crystallization and the aging of the hydrogel mixture in the same vessel does not negatively affect the zeolite-Y particles formed.

This disclosure includes numerous aspects. One aspect is a method of making zeolite-Y particles, the method comprising: forming a zeolite precursor solution comprising an alumina source material and a silica source material in a solvent; and subjecting the zeolite precursor solution to a heating process to form the zeolite-Y particles, the heating process comprising a first heating treatment and a second heating treatment, wherein the second heating treatment follows the first heating treatment, wherein the first heating treatment comprises exposure to a temperature of from 50° C. to 120° C. under non-autoclave conditions and the second heating treatment comprises exposure to a temperature of from 80° C. to 120° C. under autoclave conditions.

Another aspect is any above aspect or combination of aspects, wherein forming the zeolite precursor solution and the first heating treatment are performed in the same vessel.

Another aspect is any above aspect or combination of aspects, wherein the first heating treatment is for a time period of from 12 hours to 96 hours and the second heating treatment is for a time period of from 12 hours to 24 hours.

Another aspect is any above aspect or combination of aspects, wherein the method does not utilize an organic structure-directing agent.

Another aspect is any above aspect or combination of aspects, wherein the alumina source material is chosen from one or more of NaAlO₂, Al₂(SO₄)₃, Al(NO₃)₃, AlCl₃, or Al₂O₃.

Another aspect is any above aspect or combination of aspects, wherein the silica source material is chosen from one or more of colloidal silica, fumed silica, tetraethyl orthosilicate, or Na₂SiO₄.

Another aspect is any above aspect or combination of aspects, wherein the first heating treatment comprises exposure to a temperature of from 50° C. to 70° C. for a time period of from 12 hours to 24 hours.

Another aspect is any above aspect or combination of aspects, wherein the second heating treatment comprises exposure to a temperature of from 90° C. to 110° C. for a time period of from 12 hours to 15 hours.

Another aspect is any above aspect or combination of aspects, wherein forming zeolite precursor solution comprises: mixing a basic compound, the silica source material, and the alumina source material into a solvent to form a mixture; and aging the mixture by stirring the mixture for at least 10 hours.

Another aspect is any above aspect or combination of aspects, wherein the solvent is water.

Another aspect is any above aspect or combination of aspects, wherein aging the mixture comprises stirring the mixture at a temperature of from 20° C. to 40° C.

Another aspect is any above aspect or combination of aspects, wherein aging the mixture comprises stirring the mixture for from 10 hours to 30 hours.

Another aspect is any above aspect or combination of aspects, wherein the basic compound is chosen from one or more of NaOH, KOH, or Mg(OH)₂.

Another aspect is any above aspect or combination of aspects, wherein the alumina source material is not aluminum isopropoxide.

Another aspect is any above aspect or combination of aspects, wherein the zeolite-Y particles have an average particle size of from 150 nm to 250 nm.

Another aspect is any above aspect or combination of aspects, wherein the zeolite-Y particles have an average pore size of from 2 to 5 nm.

Another aspect is any above aspect or combination of aspects, wherein the zeolite-Y particles have a total pore volume of from 0.5 ml/g to 1.0 ml/g.

Another aspect is any above aspect or combination of aspects, wherein the zeolite-Y particles have an average surface area of at least 500 m²/g.

Another aspect is any above aspect or combination of aspects, wherein the zeolite-Y particles have a relative crystallinity of greater than 100%.

Another aspect is any above aspect or combination of aspects, wherein the method further comprises washing the zeolite-Y particles; drying the zeolite-Y particles; and calcinating the zeolite-Y particles.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butene may include a mixture of various isomers of butene. It should be appreciated that the examples supply compositional ranges for various streams, and that the total amount of isomers of a particular chemical composition can constitute a range.

What is claimed is:

1. A method for making zeolite-Y particles, the method comprising:
forming a zeolite precursor solution comprising an alumina source material and a silica source material in a solvent; and
subjecting the zeolite precursor solution to a heating process to form the zeolite-Y particles, the heating process comprising a first heating treatment and a second heating treatment, wherein the second heating treatment follows the first heating treatment, wherein the first heating treatment comprises exposure to a temperature of from 50° C. to 120° C. under non-autoclave conditions and the second heating treatment comprises exposure to a temperature of from 80° C. to 120° C. under autoclave conditions.

2. The method of claim 1, wherein forming the zeolite precursor solution and the first heating treatment are performed in the same vessel.

3. The method of claim 1, wherein the first heating treatment is for a time period of from 12 hours to 96 hours and the second heating treatment is for a time period of from 12 hours to 24 hours.

4. The method of claim 1, wherein the method does not utilize an organic structure-directing agent.

5. The method of claim 1, wherein the alumina source material is chosen from one or more of NaAlO₂, Al₂(SO₄)₃, Al(NO₃)₃, AlCl₃, or Al₂O₃.

6. The method of claim 1, wherein the silica source material is chosen from one or more of colloidal silica, fumed silica, tetraethyl orthosilicate, or Na₂SiO₄.

7. The method of claim 1, wherein the first heating treatment comprises exposure to a temperature of from 50° C. to 70° C. for a time period of from 12 hours to 24 hours.

8. The method of claim 1, wherein the second heating treatment comprises exposure to a temperature of from 90° C. to 110° C. for a time period of from 12 hours to 15 hours.

9. The method of claim 1, wherein forming zeolite precursor solution comprises:
mixing a basic compound, the silica source material, and the alumina source material into a solvent to form a mixture; and
aging the mixture by stirring the mixture for at least 10 hours.

10. The method of claim 9, wherein the solvent is water.

11. The method of claim 9, wherein aging the mixture comprises stirring the mixture at a temperature of from 20° C. to 40° C.

12. The method of claim 9, wherein aging the mixture comprises stirring the mixture for from 10 hours to 30 hours.

13. The method of claim 9, wherein the basic compound is chosen from one or more of NaOH, KOH, or Mg (OH) 2.

14. The method of claim 1, wherein the alumina source material is not aluminum isopropoxide.

15. The method of claim 1, wherein the zeolite-Y particles have an average particle size of from 150 nm to 250 nm.

16. The method of claim 1, wherein the zeolite-Y particles have an average pore size of from 2 to 5 nm.

17. The method of claim 1, wherein the zeolite-Y particles have a total pore volume of from 0.5 ml/g to 1.0 ml/g.

18. The method of claim 1, wherein the zeolite-Y particles have an average surface area of at least 500 m²/g.

19. The method of claim 1, wherein the zeolite-Y particles have a relative crystallinity of greater than 100%.

20. The method of claim 1, further comprising:
washing the zeolite-Y particles;
drying the zeolite-Y particles; and
calcinating the zeolite-Y particles.
